(19) United States
(12) Patent Application Publication
(10) Pub. No.: US 2021/0233382 A1
(43) Pub. Date: Jul. 29, 2021

(54) SYSTEM AND METHOD FOR AN ALERT DEVICE

(71) Applicant: Alertpoint, LLC, Kennesaw, GA (US)

(72) Inventor: David Gordon Allen, Acworth, GA (US)

(21) Appl. No.: 17/159,405

(22) Filed: Jan. 27, 2021

Related U.S. Application Data
(60) Provisional application No. 62/966,603, filed on Jan. 28, 2020.

(51) Int. Cl. G08B 25/01; G08B 21/02; G08B 25/10; G08B 25/00; G08B 5/36

(52) U.S. Cl. CPC G08B 25/016; G08B 21/02; G08B 5/36; G08B 25/009; G08B 25/10

(57) ABSTRACT

An alert device, a method of using an alert device, and a personnel security system including an alert device. The alert device includes an attachment mechanism and a housing coupled together. The housing is configured to transmit a signal. The method of using an alert device includes releasably attaching an alert device to a human body, activating a sensor on the alert device, generating an alert from the alert device, receiving the alert in a receiver, identifying a location of the alert device based at least in part on a location of the receiver, and providing notification of the alert and the location of the alert device.

### CROSS-REFERENCE TO RELATED APPLICATIONS

This application claims the benefit of the following U.S. Provisional Application No. 62/966,603, filed on Jan. 28, 2020; the entire contents of which are incorporated herein by reference.

### TECHNICAL FIELD

The present disclosure generally applies to the field of security, particularly in buildings with numerous rooms such as are often found in the lodging space (e.g., hotels, motels, etc.).

### BACKGROUND

Security and safety are an essential facet of any business. Especially in the hospitality industry, a guest will always expect a safe place to stay. This expectation of safety is becoming increasingly an important expectation for the employees as well as the guests. Personal safety has become one of the most debilitating workplace stress factors for housekeeping staff today in the hospitality industry. Housekeeping staff and other employees who work alone or in vulnerable areas must deal with the potential for personal harm on a daily basis.

Employees need a quick way to notify the appropriate personnel of unsafe situations. Especially in locations, such as lodging building rooms or bathrooms, where traditional security measures, such as security cameras, cannot be implemented, employees need to be able to send an alert to the appropriate personnel of their location, quickly and precisely.

In an effort to reduce incidents of violence in the hospitality industries and in workplaces generally, everyone is encouraged to report suspicious activity and to seek help quickly to resolve potential threats. However, conventional alert management systems are unable to quickly and efficiently report an emergency or provide an alert to others who can help.

### SUMMARY OF THE DISCLOSURE

As will be discussed in greater detail below, embodiments of the present disclosure include an alert device that may send a signal to ultimately alert the appropriate personnel. The signal from the alert device may be used to locate the personnel who triggered the sensor.

In one example implementation, an alert device is provided. The alert device may include an attachment mechanism configured to be worn by a user and a housing. The housing may be coupled with the attachment mechanism. The housing may be configured to transmit a signal. The housing may include a sensor configured to activate a wireless transmitter to transmit the signal, a processor, a storage medium, and a wireless transmitter. The signal may be configured to activate a security protocol and provide room-level location information.

One or more of the following example features may be included. The security protocol may include a location of the alert device, and a notification that the alert device transmitted the signal. The signal may be encoded by a Bluetooth® protocol. The sensor may include at least one of a switch, a button, and a touch sensor. In some embodiments, the alert device may not include internet connectivity.

In another example implementation, a method of using an alert device is provided. The method may include releasably attaching an alert device to a human body and receiving a sensor activation signal on the alert device. The method may further include generating an alert from the alert device using a Bluetooth® protocol and receiving the alert in a receiver via the Bluetooth® protocol. The method may also include identifying a location of the alert device based at least in part on a location of the receiver and providing notification of the alert and the location of the alert device.

One or more of the following example features may be included. The method may further includes activating an emergency light coupled with the receiver. The method may further include displaying the location of the alert device. The notification of the alert and the location of the alert device may be transmitted to at least one of police, first responders, security, and lodging building management. The alert may be a wireless signal. The method may also include locating a plurality of receivers into unique locations, wherein the plurality of receivers are uniquely identifiable based on their respective unique locations. The alert device may be releasably attached to a wrist of the human body. Each of the plurality of receivers may be assigned to a distinct room location with a lodging building.

In another example implementation, a personnel security system is provided. The system may include a plurality of alert devices, wherein each of the plurality of alert devices is configured to transmit a unique identifier. The unique identifier may be configured to uniquely identify each one of the plurality of the alert device based on the signal. The system may include a plurality of receivers each configured to receive the signal, the plurality of receivers are positioned in rooms of a lodging building. The plurality of receivers may be configured to determine a strength of the signal from the alert device.

In another example implementation, a housing is provided. The housing may include a receiver housing and an outlet wall plate attachable to a front face of an electrical outlet. The receiver housing and the outlet wall plate may be configured to surround a receiver. The receiver may be configured to be in electrical communication with the electrical outlet while surrounded by the outlet wall plate and the receiver housing.

One or more of the following example features may be included. The receiver housing may be releasably attachable to the outlet wall plate by a specialty screw including a drive and a head. The drive may include a protrusion located about the center of the head and a recess surrounding the protrusion. The recess may include at least one semicircle cutout located on an edge on the recess protruding into the head. The receiver housing may include at least one window and wherein the at least one window comprises at least one of a transparent or semi-transparent covering. The at least one window may be configured to allow access to a receiver input device.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

This summary is provided to introduce a selection of concepts that are further described below in the detailed description. This summary is not intended to identify essential features of the claimed subject matter, nor is it intended to be used as an aid in limiting the scope of the claimed subject matter.

### BRIEF DESCRIPTION OF THE DRAWINGS

Embodiments of the present disclosure are described with reference to the following figures.

FIG. 1 is a diagrammatic view of a distributed computing network including a computing device that executes an alert according to an embodiment of the present disclosure;

FIG. 2 illustrates a method of using an alert device within a personnel security network;

FIG. 3 illustrates an alert device within a lodging building equipped with receivers according to an embodiment of the present disclosure;

FIG. 4 illustrates an exemplary flow chart of data transmission after an alert device transmits a signal;

FIG. 5 illustrates an alert device according to an embodiment of the present disclosure;

FIG. 6 illustrates a receiver housing; and

FIG. 7 illustrates a security screw.

Like reference symbols in the various drawings may indicate like elements.

### DETAILED DESCRIPTION

The discussion below is directed to certain implementations. It is to be understood that the discussion below is only for the purpose of enabling a person with ordinary skill in the art to make and use any subject matter defined now or later by the patent “claims” found in any issued patent herein.

It is specifically intended that the claimed combinations of features not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered a same object or step.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc. It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

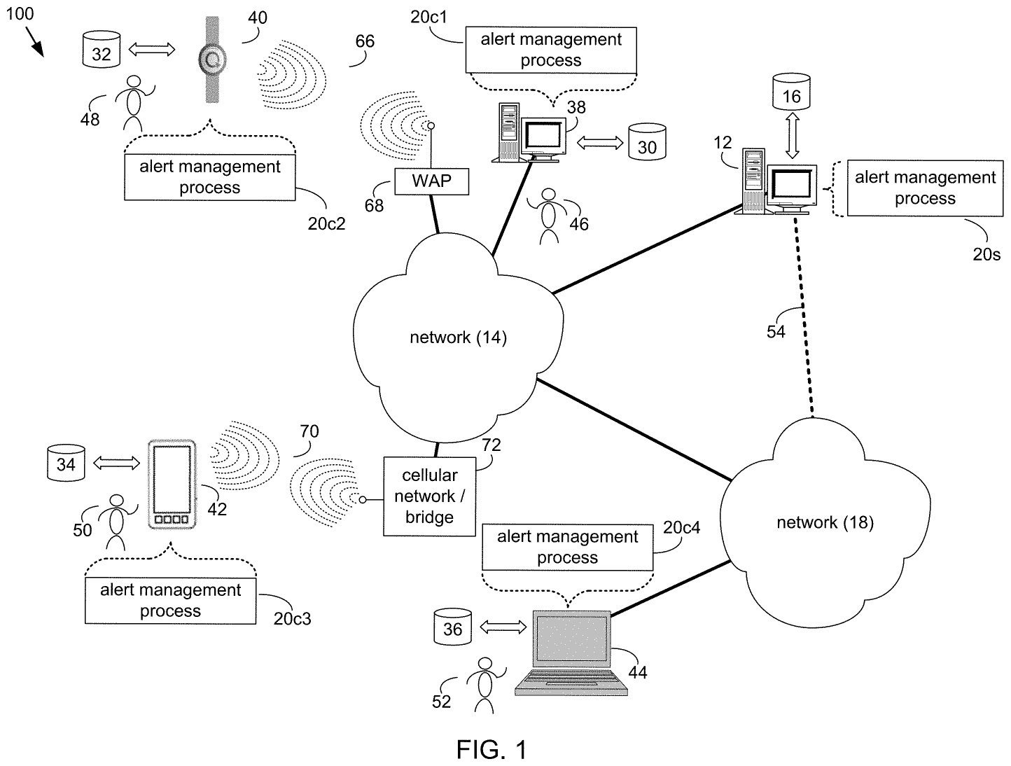

Referring to the example implementation of FIG. 1, there is shown alert management process 20. Alert management process 20 may be implemented as a server-side process, a client-side process, or a hybrid server-side/client-side process.

For example, alert management process 20 may be implemented as a purely server-side process via alert management process 20s. Alternatively, alert management process 20 may be implemented as a purely client-side process via one or more of alert management process 20c1, alert management process 20c2, alert management process 20c3, and alert management process 20c4. Alternatively still, alert management process 10 may be implemented as a hybrid server-side/client-side process via alert management process 20s in combination with one or more of alert management process 20c1, alert management process 20c2, alert management process 20c3, and alert management process 20c4. Accordingly, alert management process 10 as used in this disclosure may include any combination of alert management process 20s, alert management process 20c1, alert management process 20c2, alert management process 20c3, and alert management process 20c4.

Alert management process 20s may be a server application and may reside on and may be executed by computing device 12, which may be connected to network 14 (e.g., the Internet, a local area network, or combination thereof). Examples of computing device 12 may include, but are not limited to: a personal computer, a server computer, a series of server computers, a mini computer, a mainframe computer, or a cloud-based computing network.

The instruction sets and subroutines of alert management process 20s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of alert management processes 20c1, 20c2, 20c3, 20c4 may include but are not limited to a corporate user interface, a web browser, or a specialized application (e.g., an application running on e.g., the Android platform or the iOS platform). The instruction sets and subroutines of alert management processes 20c1, 20c2, 20c3, 20c4, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Examples of storage devices 30, 32, 34, 36 may include but are not limited to: hard disk drives; RAID devices; random access memories (RAM); read-only memories (ROM), and all forms of flash memory storage devices.

Examples of client electronic devices 38, 40, 42, 44 may include, but are not limited to: personal computer 38; specialty devices such as alert device 40; smartphone 42 or other data enabled cellular phone; laptop computer 44; a notebook computer (not shown); a server computer (not shown); a dedicated network device (not shown); and a tablet computer (not shown).

Client electronic devices 38, 40, 42, 44 may each execute an operating system, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

Users 46, 48, 50, 52 may access alert management process 20 directly through network 14 or through secondary network 18. Further, alert management process 10 may be connected to network 14 through secondary network 18, as illustrated with link line 54.

The various client electronic devices (e.g., client electronic devices 38, 40, 42, 44) may be directly or indirectly coupled to network 14 (or network 18). For example, alert device 40 is shown wirelessly coupled to network 14 via wireless communication channels 66 established between alert device 40 and wireless access point (i.e. WAP) 68, which is shown directly coupled to network 14. Further, smartphone 42 is shown wirelessly coupled to network 14 via wireless communication channels 70 established between smartphone 42 and cellular network/bridge 72, which is shown directly coupled to network 14. Additionally, personal computer 38 is shown directly coupled to network 14 via a hardwired network connection. Additionally, laptop computer 44 is shown directly coupled to network 18 via a hardwired network connection.

WAP 68 may be, for example, an IEEE 802.11a, 802.11b, 802.11g, 802.11n, Wi-Fi, and/or Bluetooth device that is capable of establishing wireless communication channel 66 between alert device 40 and WAP 68. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth® is a telecommunications industry specification that allows e.g., mobile phones, computers, personal digital assistants and internet of things (IoT) devices to be interconnected using a short-range wireless connection. In some implementations WAP 68 may be incorporated into a specialty device as will be discussed in greater detail below.

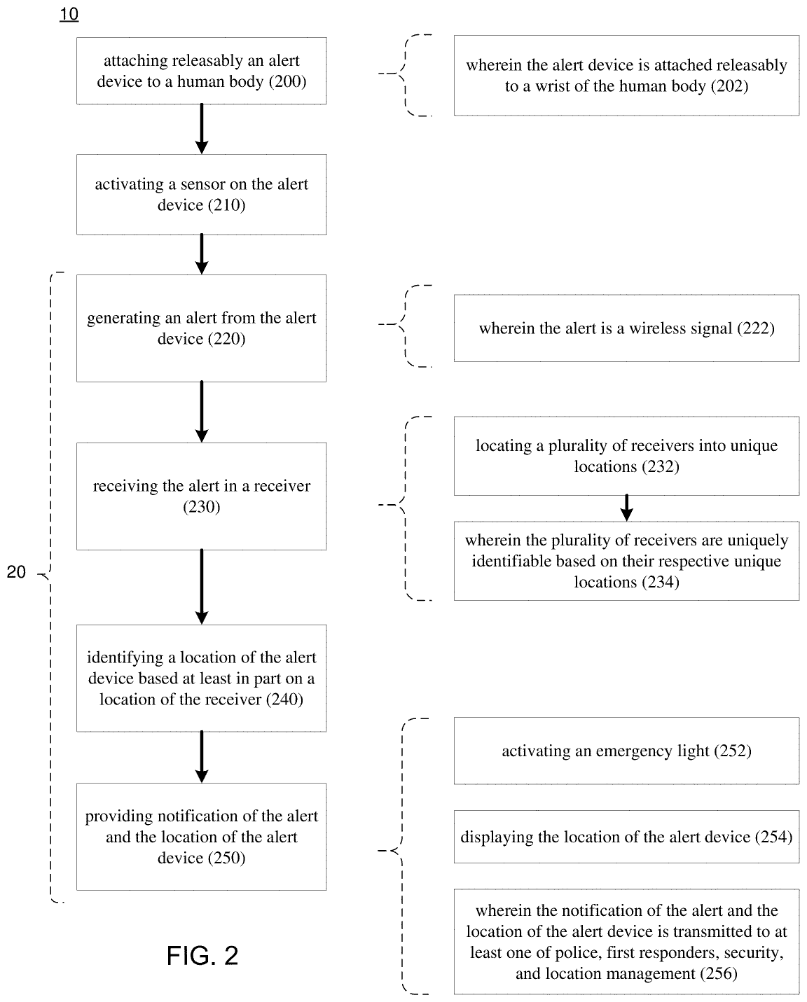

Referring to FIGS. 2-5 and as will be discussed in greater detail below, embodiments of the present disclosure may comprise a blend of hardware, software and wireless technologies to ensure fast, accurate, and reliable emergency communication when it's needed most. From alert activation to alert tracking, embodiments of the present disclosure may provide a full complement of capabilities to automate and accelerate the alert and crisis management process.

In addition, embodiments of the present disclosure may utilize a mesh network of receivers that may include both notifying (e.g., color-coded visual and audible alerts) and locating capability, which extends to exterior coverage, creating a robust security net that reaches places all places of a lodging building such as, for example, lodging building rooms, hallways, storage areas, kitchen areas, office areas, conference rooms, and maintenance areas.

As will be discussed in greater detail below and in some implementations, the alert communication devices (i.e. an alert device) may not only signal a specific emergency response and/or security protocol through flashing LEDs, they may also communicate critical locating data to inform response. In some implementations, this information is instantly sent to and presented on multiple devices (desktop/laptop, mobile phone, and TV) in the form of a floor view (single location) and map view (multiple locations), and displays are updated dynamically as changes occur.

In some implementations and as discussed above, alert management process 20 may reside on and may be executed by storage system 12; and may be configured to process the above-described alert signals through the alert management process 20.

As discussed above and referring also to the example implementation of FIG. 2, the method 10 of using an alert device may include alert management process 20. For example and referring also to FIG. 2, the method 10 of using an alert device may include attaching 200 releasably an alert device to a human body, activating 210 a sensor on the alert device, generating 220 an alert from the alert device, receiving 230 the alert in a receiver, identifying 240 a location of the alert device based at least in part on a location of the receiver, and providing 250 notification of the alert and the location of the alert device. In some implementations and as discussed above the method 10 of using an alert device and/or the alert management process 20 may further include an alert device configured to attach releasably to a wrist of the human body 202, an alert that may be transmitted as wireless signal 222, and the notification of the alert and the location of the alert device may be transmitted to at least one of police, first responders, security, and lodging building management 256. In some implementations and as discussed above the method 10 of using an alert device and/or the alert management process 20 may further include locating 232 a plurality of receivers into unique locations, the plurality of receivers may be uniquely identifiable based on their respective unique locations 254, activating 252 an emergency light, and displaying 254 the location of the alert device.

As discussed above, in some implementations the method 10 of using an alert device may include attaching 200 releasable an alert device to the human body. In other implementations, the alert device may be permanently attached or releasably attached to an object used by lodging building cleaning staff. As will be discussed further below the method 10 of using an alert device can include an alert device that may be configured to attach releasably to a wrist of a human 202. The attaching releasably may be accomplished by having the alert device include, but is not limited to: a band and buckle, hook and loop straps, latches, snaps and/or buttons.

As discussed above, in some implementations the method 10 of using an alert device may include activating 210 a sensor on the alert device. The sensor may include any combination of devices for example, but not limited to, push buttons, switches, optical sensors, touch sensors, and/or voice activated sensors. The alert device may include more than one sensor.

As discussed above, in some implementations the method 10 of using an alert device may include generating 220 an alert from the alert device. In some implementations, activating 210 the sensor may trigger generating 220 an alert which may begin the alert management process 20. The alert device may generate and may transmit the alert as wireless signal 222. The alert from the alert device in some implementations may be generated without any indication that the alert has been generated. In other words the alert may be generated by the alert device without audio or visual cues that the sensor has been activated and an alert is being generated. A silent generation would prevent any potential attacker from knowing that help is on the way. In other embodiments, while the alert device is generating a signal a light and/or sound may also be generated to notify the user that the sensor was activated appropriately.

As discussed above, in some implementations the method 10 of using an alert device may include receiving 230 the alert in a receiver. The receiver, for example, can include devices such as WAP 68 from FIG. 1, transceivers, smartphones, or other specialty devices configured to receive an alert from an alert device. The receiver may be configured to relay the alert to network 14 from FIG. 1.

In some implementations there are numerous receivers and the method 10 of using an alert device may include locating 232 a plurality of receivers into unique locations. This plurality of receivers may create a better coverage network to receive alerts from the alert device. Including the plurality of receivers uniquely spread out through the lodging building may avoid a situation where an alert is not received because the numerous walls and corridors from the lodging building rooms weaken the alert transmission. The plurality of receivers may or may not be in communication with one another. If the plurality of receivers are in communication with one another the plurality of receivers may form a mesh network. The plurality of receivers may be uniquely identifiable based on their respective unique locations 254.

As discussed above, in some implementations the method 10 of using an alert device may include identifying 240 a location of the alert device based at least in part on a location of the receiver. In some implementations, the unique locations of each of the plurality of receivers may create a corresponding location for where to locate the alert device generating the alert. In other words, if an alert is picked up by only one receiver then the alert device is near that one receiver. In other implementations, if the alert is received by more than one receiver, the corresponding signal strength of the alert may help determine the location of the alert device. In other implementations the alert received by multiple receivers may be triangulated to determine the location of the alert device.

As discussed above, in some implementations the method 10 of using an alert device may include providing 250 notification of the alert and the location of the alert device. In some implementations, the provided 250 notifications of the alert may be sent to at least one of a personal computer, laptop computer, smartphone, cell phone, specialty device and/or a pager (e.g. the user devices from FIG. 1). In some implementations, the notification of the alert and the location of the alert device may be transmitted to at least one of police, first responders, security, and lodging building management 256. The notification can be sent as various formats including, but not limited to, text based, image based and a combination of both formats.

As discussed above, in some implementations the method 10 of using an alert device may include activating 252 an emergency light. The emergency light may be located with the receiver and/or located in a separate location and housing. There may be one emergency light located in a central location like the administrative office and/or security office of the lodging building to provide a visual notification that the alert device was triggered. In other implementations, there may be a plurality of emergency lights distributed across a building or specifically a lodging building.

As discussed above, in some implementations the method of using an alert device may include displaying 254 the location of the alert device. The location of the alert device may be displayed within the context of a diagram of the building, or specifically, a diagram of the lodging building. The location of the alert device may be transposed over a floor plan of the building. In some implementations, the location of the alert device only needs to be approximate because, for example, just knowing what room and floor a cleaning staff member is in while the alert device is generating an alert is enough for help to locate them.

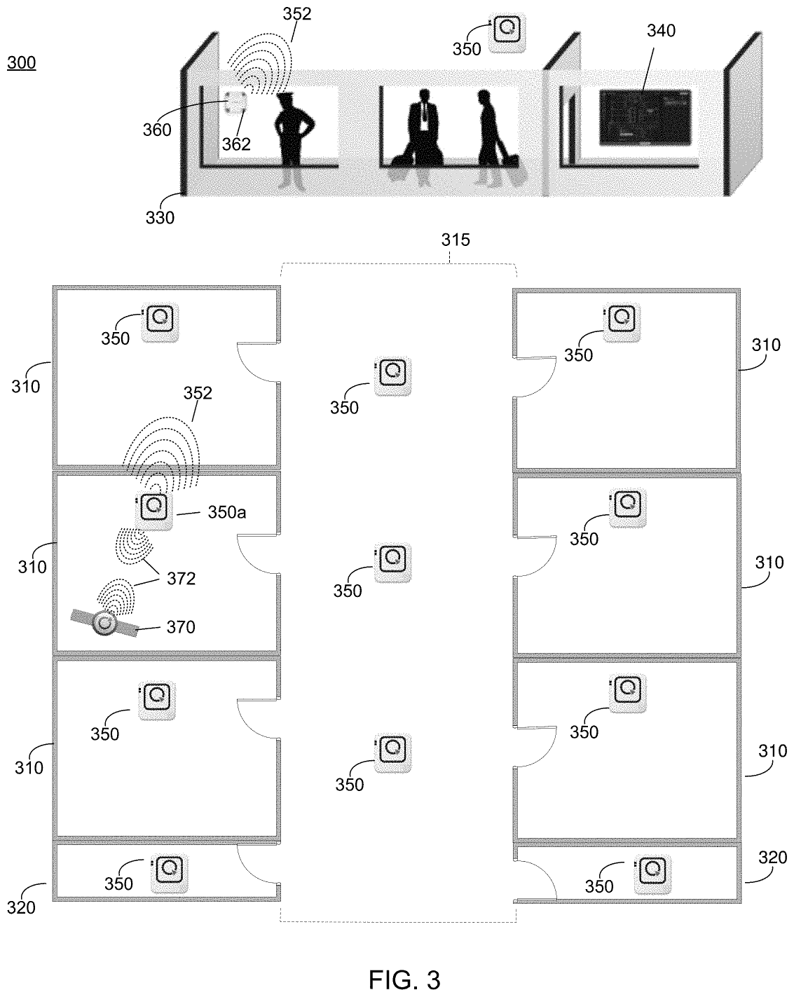

Referring to FIG. 3 there is shown an example implementation of the method 10 of using an alert device. Specifically, FIG. 3 shows a representation of a floor plan of a lodging building including lodging building rooms 310, a hallway 315, storage areas 320, and administrative area 330. Within the lodging building, or generally a building, there may be a plurality of receivers 350 to receive the alert signal 372 transmitted by the alert device 370. Specifically in this embodiment, receiver 350a received the alert signal 372. In the embodiment shown in FIG. 3, receiver 350a transmits a second signal 352 to a second receiver 360 in the administrative area 330. The second receiver 360 may contain emergency lights, as explained above, to visually notify the administrative area 330 of an alert device 370 being triggered. In the embodiment of FIG. 3, the administrative area 330 is notified of the alert signal 372, generated from alert device 370, by an emergency light 362 and the location is provided by illuminating a portion of floor plan 340.

As discussed above, in some embodiments there are a plurality of receivers 350, 350a located in lodging building rooms 310, a hallway 315, storage area 320, and administrative area 330. In other embodiments, there may be more or less receivers 350 to provide coverage for alert signal 372 to be received in any location within the building that an employee may travel (e.g. lodging building rooms 310, a hallway 315, storage area 320, and administrative area 330). Additionally areas within the lodging building may have more than one receiver in the area, just as hallway 350 is depicted in FIG. 3 to include a plurality of receivers 350. In some implementations, the plurality of receivers 350 may be in communication with one another and operate as a mesh network.

As discussed above, in some embodiments there are may be a second receiver 360 to pick up the second signal 352. In other embodiments there may be just one type of receiver 350, or more than the two receivers 350, 360 as depicted in FIG. 3. As previously discussed, in some embodiments the receivers may be configured to transmit signals wirelessly and/or transmit signals over cables, for example, such as ethernet cables, to a central and remote location. Second receiver 360 may be equipped with additional features as compared to receiver 350, for example emergency light 352 and may be configured to receive only certain types of signals. The second receiver 360 may be configured to function as gateway connected to a plurality of receivers 350. The receiver 350 and/or the second receiver 360 may be configured to function as a Bluetooth® and/or Bluetooth® Low Energy transceiver. With integrated Bluetooth Low Energy®, the alert activation device may allow beaconing capability for device locating.

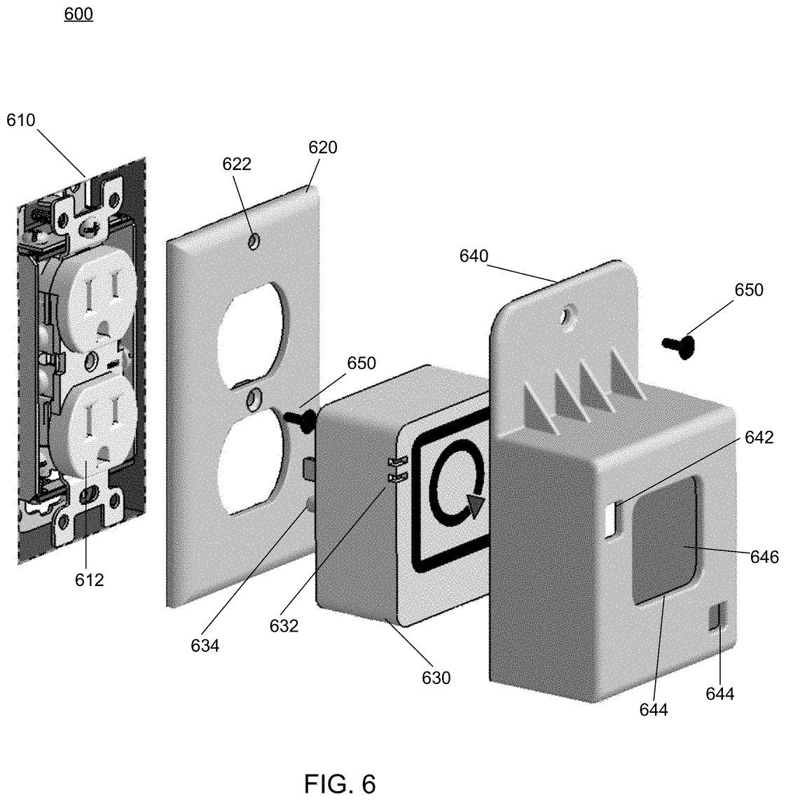

As will be discussed further with respect to FIG. 6, receivers 350, 360 may be housed and mounted in housing 600. In other embodiments the receivers 350, 360 may be mounted in inconspicuous locations such as, but not limited to, on the ceiling or the respective mounting areas.

As discussed above, in some embodiments the location may be provided by illuminating a portion of a floor plan. In other embodiments the location may be provided via an image on a computer monitor or just a text-based notification of the location. The text-based notification may include which receiver 350 had been triggered.

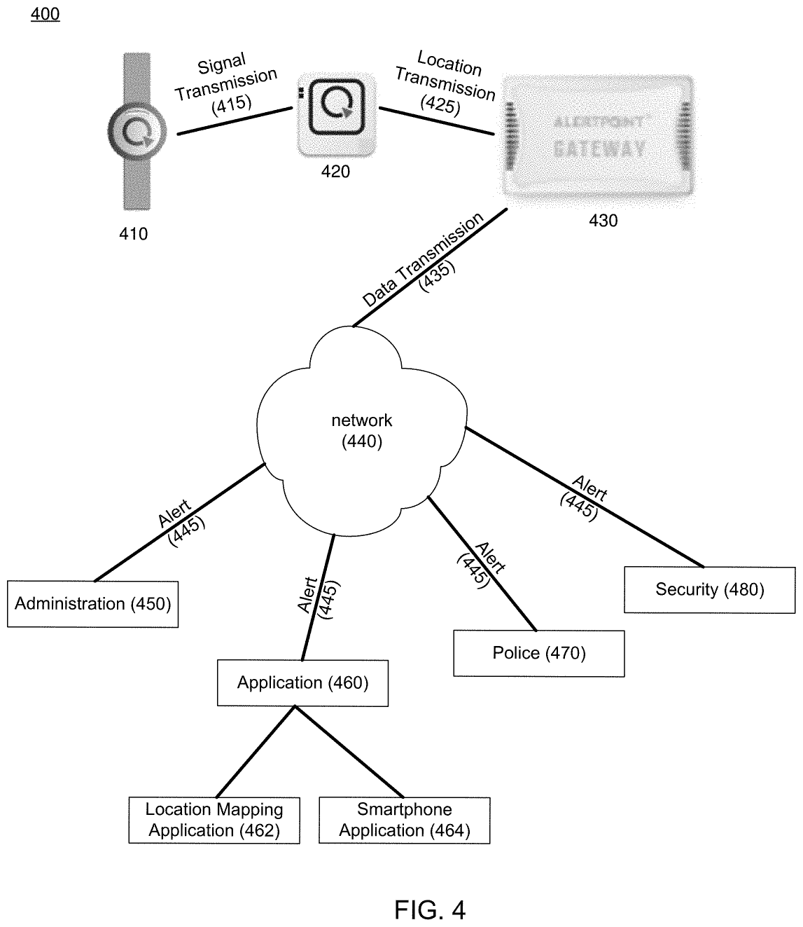

Referring to FIG. 4 there is shown another example implementation of the method 10 of using an alert device. FIG. 4 specifically depicts via a diagram how information may move through the system configured to work with alert device 410, once alert device 410 is triggered. For example in one implementation, once a sensor on alert device 410 is triggered a signal 415 is transmitted to receiver 420. Receiver 420 may transmit the location of the alert device 410 that had bene triggered to a second receiver 430. The second receiver 430 may be additionally configured to act as a gateway or a relay for the receiver 420. Second receiver 430 may transmit the data 435 from receiver 420 and alert 410 to the network 440. The network 440 may include steps from method 10 of using an alert device to provide an alert 445. The alert 445 may be provided to building administration 450, an application 460, police 470, and/or security 480. For example, application 460 may include, but is not limited to, a location mapping application 462, and a smartphone application 464.

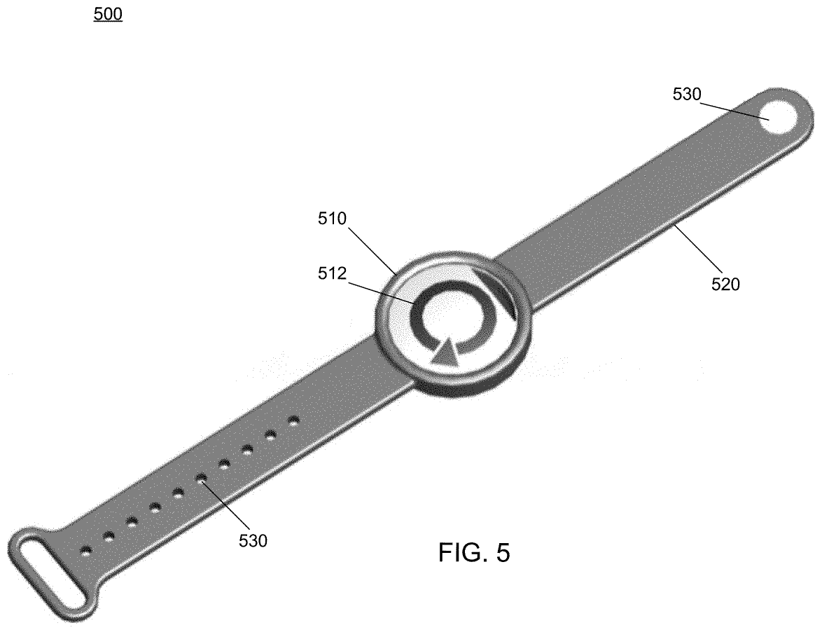

Referring to FIG. 5 there is shown another example implementation of the method 10 of using an alert device. Specifically FIG. 5 depicts an alert device 500, as previously discussed, that triggers an alert. The alert device 500 may include a housing 510, a sensor 512, an attachment strap 520, and an attachment mechanism 530.

In some embodiments the alert device 500 may further include a processor, a storage medium, a wireless transmitter, a power supply, and an antennae within, or coupled to, the housing 510. The alert device may also include a GPS coordinate or other location information that may be sent over the wireless transmitter. The alert device 500 may be configured to act as a locating beacon and/or transmit a signal intermittently, before and/or after the sensor is activated. The alert device 500 may be configured to encode a signal to activate the receivers and thereby activate the method 10 of using an alert device. The alert device 500 may be configured to use Bluetooth® and/or Bluetooth Low Energy®. The alert device 500 may send information directly to the network in addition to the receiver. In some embodiments the alert device 500 may transmit a unique identifier to allow for identification of the alert device 500 if a plurality of alert devices are utilized in the same area.

As discussed above, the alert device 500 may include a sensor 512. In other embodiments there may be a plurality of sensors on the housing. The plurality of sensors can be configured to transmit different signals to implement different variations of the method 10 for using an alert device depending on the sensor triggered. For example, alert device 500 may include two sensors 512 on the housing 510, one sensor may be configured to trigger a minor emergency protocol from just security, and the other sensor may be configured to indicate immediate help from more than one party is required (e.g. security and police). As previously discussed the sensor 512 may include any combination of devices, for example the sensors may include, but are not limited to, push buttons, switches, optical sensors, touch sensors, and/or voice activated sensors. The alert device may include more than one sensor.

As discussed above, the alert device 500 may include attachment strap 520 and an attachment mechanism 530 coupled to the housing 510. The attachment strap 520 may be made of any material suitable to be in contact with the human body. In some implementations, the attachment strap 520 may be made of a soft, durable, water resistant material. In some implementations the attachment mechanism 530 is configured to secure the attachment strap 520. The attachment mechanism 530 and the attachment strap 520 may circumscribe the wrist. The attachment mechanism 530 may include but is not limited to a clasp, hook and loop, a buckle, a button, and a tie portion.

Referring to FIG. 6, there is shown another example implementation of the method 10 of using an alert device. Specifically, the method 10 may include a housing 600. The housing 600 may include a receiver housing 640, and an outlet wall plate 620 attachable to a front face 612 of an electrical outlet 610, where the receiver housing 640 and the outlet wall plate 620 are configured to surround a receiver 630. The housing 600 may be used to protect or conceal the receiver 630. Receiver 630 may be configured to receive the signal from the alert device (e.g. alert device 370 and alert signal 372 as depicted in FIG. 3).

In some embodiments the receiver 630 may be configured to be in electrical communication with the electrical outlet 610. The receiver 630 may be surrounded by the outlet wall plate 620 and the receiver housing 640 while in electrical communication with electrical outlet 610. As depicted in FIG. 6, the electrical communication may be achieved by allowing electrical prongs 634 to pass through the outlet wall plate 620 unobstructed by the receiver housing 640. In other embodiments a cable may pass from the receiver housing 640 to electrical outlet 610.

As discussed above, in some embodiments the housing may include a receiver housing 640, and an outlet wall plate 620 attachable to a front face 612 of an electrical outlet 610, where the receiver housing 640 and the outlet wall plate 620 are configured to surround a receiver 630. In some embodiments, the receiver housing 640 may surround all sides of the receiver. In other embodiments, the receiver housing 640 may not completely surround the face of the receiver 630 adjacent to the outlet wall plate 620. In other embodiments, the receiver housing 640 may surround all sides of the receiver 630 and the receiver housing 640 may have openings to allow features like prong 634 to protrude from the receiver housing 640. In some embodiments, the receiver housing 640 may be spaced away from the outlet wall plate 620. In some embodiments, the receiver 630 may be offset from the outlet wall plate 620. In some embodiments, the receiver 630 may be surrounded by the receiver housing 640, and outlet wall plate 620 and/or electrical outlet 610 may not be present. In such embodiments receiver 630 may be powered by a battery or other power source to allow for mounting locations that may not have electrical outlets 610 readily available.

As discussed above, the receiver housing 640 may be releasably attachable to the outlet wall plate 620 by devices such as, but not limited to, at least one of a screw, bolt, nail, adhesive, hook and loop tape, and a specialty screw 650. Specialty screw 650 may be used for various purposes in the housing 600 such as releasably attaching the outlet wall plate 620 to the outlet 610, and/or attaching the receiver housing 640 to the outlet wall plate 620.

Specialty screw 650 may attach receiver housing 640 to outlet wall plate 620 by a screwing into hole, such as hole 622. In other embodiments, the specialty screw 650 may be configured to hold together into at least two of the outlet 610, outlet wall plate 620, receiver 630 and receiver housing 640. In implementations that utilize adhesives (or other attachment devices such as the examples devices listed above), the adhesive, the outlet wall plate 620, and the receiver housing 640 may surround the receiver 630.

As discussed above, the receiver housing 640 may include at least one window 644. Receiver housing 640, as depicted in FIG. 6, may include windows such as windows 642, 644. The at least one window 644 may include at least one of a transparent or semi-transparent covering 646. The at least one of a transparent or semi-transparent covering 646 may allowed for signals to be better transmitted and received through receiver housing 640. In other implementations, the at least one of a transparent or semi-transparent covering 646 may provide visual access to the receiver 630 to see lights or displays on the receiver 630. The at least one window, such as window 642 may be configured to allow direct access to a receiver input device 632. The receiver input device 632 may include, but is not limited to, buttons and/or communication ports. The at least one window (e.g. window 642 and windows 644) may include other coverings such as doors that access the receiver 630. The doors may include locking mechanisms to prevent unauthorized access to the receiver 630.

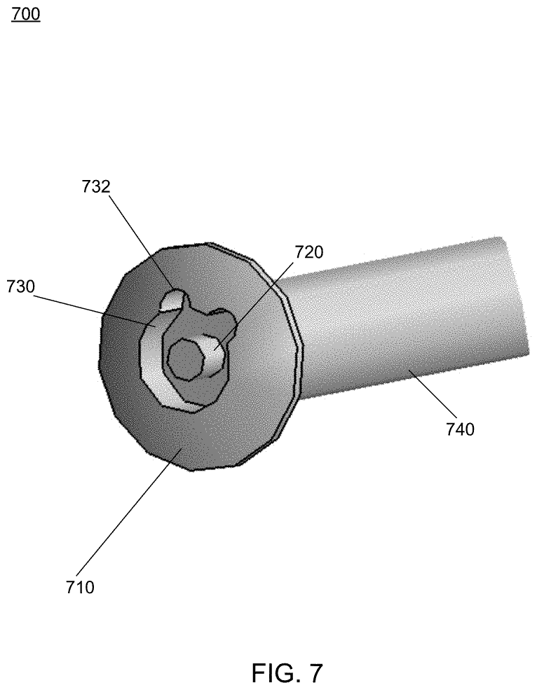

The specialty screw 650 is further depicted in FIG. 7. Specialty screw 700 may include a drive 730, a head 710, and a shaft 740. The drive 730 comprises a protrusion 720 located about the center of the head 710 and a recess surrounding the protrusion 720. The recess may include at least one semicircle cutout 732 located on an edge on the recess protruding into the head 710. In other implementations, the recess may include other cutouts shaped differently than located on the edge of the recess to create different shapes with different levels of security. The recess, protrusion 720, and at least one semicircle cutout 732 provide additional protection to accessing the receiver (e.g. receiver 630) contained within the receiver housing (e.g. receiver housing 640). To loosen specialty screw 700, a tool (such as a screwdriver) needs a head that can fit into the recess of the drive 730 as well as provide torque to spin the specialty screw 700. In some implementations the shaft 740 may be threaded or partially threaded.

Specialty screw 700 may be used in some implementations of the method 10 of using an alert device such as but not limited to, mounting a receiver (e.g. receiver 350 and receiver 630) to a wall and/or securing the internal components of the receiver. In other implementations the specialty screw 700 may be used to secure the internal components of the alert device from tampering. In other implementations, the specialty screw 700 may be used in place of another attachment device, such as, but not limited to, a screw with a Philips drive or flat head drive, to prevent unauthorized access by lodging building workers, or lodging building guests.

The flowchart and block diagrams in the figures illustrate the architecture, functionality, and operation of possible implementations of systems and methods and according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As used in any embodiment described herein, the term “circuitry” may comprise, for example, singly or in any combination, hardwired circuitry, programmable circuitry, state machine circuitry, and/or firmware that stores instructions executed by programmable circuitry. It should be understood at the outset that any of the operations and/or operative components described in any embodiment or embodiment herein may be implemented in software, firmware, hardwired circuitry and/or any combination thereof.

The terminology used herein is for the purpose of describing particular embodiments and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Although a few example embodiments have been described in detail above, those skilled in the art will readily appreciate that many modifications are possible in the example embodiments without materially departing from the scope of the present disclosure, described herein. Accordingly, such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

Having thus described the disclosure of the present application in detail and by reference to embodiments thereof, it will be apparent that modifications and variations are possible without departing from the scope of the disclosure defined in the appended claims.

What is claimed is:

1. An alert device comprising:
an attachment mechanism configured to be worn by a user; and
a housing coupled with the attachment mechanism, the housing is configured to transmit a signal, wherein the housing includes a sensor configured to activate a wireless transmitter to transmit the signal, a processor, a storage medium, and a wireless transmitter, wherein the signal is configured to activate a security protocol and provide room-level location information.

2. The alert device of claim 1, wherein the security protocol includes a location of the alert device, and a notification that the alert device transmitted the signal.

3. The alert device of claim 1, wherein the signal is encoded by a Bluetooth® protocol.

4. The alert device of claim 1, wherein the sensor includes at least one of a switch, a button, and a touch sensor.

5. The alert device of claim 1, wherein the alert device does not include internet connectivity.

6. The alert device of claim 1, wherein the attachment mechanism is a wristband.

7. A method of using an alert device, the method comprising:
attaching releasably an alert device to a human body;
receiving a sensor activation signal on the alert device;
generating an alert from the alert device using a Bluetooth® protocol;
receiving the alert in a receiver via the Bluetooth® protocol;
identifying a location of the alert device based at least in part on a location of the receiver; and
providing notification of the alert and the location of the alert device.

8. The method of claim 7, further comprising activating an emergency light coupled with the receiver.

9. The method of claim 7, further comprising displaying the location of the alert device.

10. The method of claim 7, wherein the notification of the alert and the location of the alert device is transmitted to at least one of police, first responders, security, and lodging building management.

11. The method of claim 7, wherein the alert is a wireless signal.

12. The method of claim 7, further comprising locating a plurality of receivers into unique locations, wherein the plurality of receivers are uniquely identifiable based on their respective unique locations.

13. The method of claim 7, wherein the alert device is releasably attached to a wrist of the human body.

14. The method of claim 12, wherein each of the plurality of receivers is assigned to a distinct room location with a lodging building.

15. A personnel security system comprising:
a plurality of alert devices, wherein each of the plurality of alert devices is configured to transmit a unique identifier, wherein the unique identifier is configured to uniquely identify each one of the plurality of the alert device based on the signal; and
a plurality of receivers each configured to receive the signal, the plurality of receivers are positioned in rooms of a lodging building.

16. The personnel security system of claim 18, wherein the plurality of receivers are configured to determine a strength of the signal from the alert device.

17. A housing comprising:
a receiver housing; and
an outlet wall plate attachable to a front face of an electrical outlet, wherein the receiver housing and the outlet wall plate are configured to surround a receiver, wherein the receiver is configured to be in electrical communication with the electrical outlet while surrounded by the outlet wall plate and the receiver housing.

18. The housing of claim 17, wherein the receiver housing is releasably attachable to the outlet wall plate by a specialty screw including a drive and a head, the drive comprises a protrusion located about the center of the head and a recess surrounding the protrusion, wherein the recess includes at least one semicircle cutout located on an edge on the recess protruding into the head.

19. The housing of claim 17, wherein the receiver housing includes at least one window and wherein the at least one window comprises at least one of a transparent or semi-transparent covering.

20. The housing of claim 17, wherein the at least one window is configured to allow access to a receiver input device.
